(19) United States
(12) Patent Application Publication
(10) Pub. No.: US 2006/0061081 A1
(43) Pub. Date: Mar. 23, 2006

(54) Compressed gas tank carrier assembly

(76) Inventors: Alfred L. Kresse JR., Romeo, MI (US); Konstantinos Triantos, Shelby Township, MI (US); David A. Young, Huntington Woods, MI (US); Mark Brady-Rajdl, Taylor, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 11/223,772

(22) Filed: Sep. 9, 2005

Related U.S. Application Data
(60) Provisional application No. 60/609,031, filed on Sep. 10, 2004.

(51) Int. Cl. B60P 3/22

(52) U.S. Cl. 280/834

(57) ABSTRACT

A carrier assembly for a compressed gas storage tank includes a first yoke defining a first concavity, and a second yoke defining a second concavity. The first and second concavities are sufficiently aligned such that a tank is at least partially containable within both the first and second concavities. In an exemplary embodiment, the first yoke also defines a third concavity and the second yoke defines a fourth concavity; the third and fourth concavities are sufficiently aligned such that another tank is at least partially containable therein. Preferably, at least one flexible strap retains the tanks with respect to the yokes.

### CROSS REFERENCE TO RELATED APPLICATIONS

This application claims the benefit of U.S. Provisional Patent Application No. 60/609,031, filed Sep. 10, 2004, and which is hereby incorporated by reference in its entirety.

### TECHNICAL FIELD

This invention relates to carrier assemblies for storing longitudinally oriented compressed gas storage tanks in a vehicle chassis.

### BACKGROUND OF THE INVENTION

Prior art vehicles typically include an internal combustion engine that is contained in an engine compartment in the front or rear of the vehicle body. The engine is fueled by a liquid, such as gasoline or diesel fuel, which is typically stored in a tank toward the rear of the vehicle. The engine drives the vehicle by applying torque to road wheels through a mechanical transmission.

Alternative vehicle fuels, such as compressed hydrogen and natural gas, have lower specific thermal energy per unit mass than more conventional fuels like gasoline and diesel fuel. Accordingly, an alternative fuel vehicle may have a significantly reduced driving range before refueling than a conventional fuel vehicle with identical fuel storage capacity. It is therefore desirable for alternative fuel vehicles to accommodate larger fuel storage tanks than those found in conventional fuel vehicles.

It is also desirable to place alternative fuel storage tanks in a protected location within the vehicle chassis. Accordingly, alternative fuel storage tanks are typically placed between the rear wheels of the vehicle. However, packaging space between the rear wheels is limited, which, in turn, limits the size of the tanks and the vehicle travel range between refuelings.

### SUMMARY OF THE INVENTION

A carrier assembly is provided to carry and constrain large compressed gas storage tanks in a vehicle. The assembly includes a first yoke that defines a first concavity. A second yoke defines a second concavity. The first and second yokes are arranged such that the first and second concavities are sufficiently aligned to at least partially contain a gas storage tank. In an exemplary embodiment, the first yoke also defines a third concavity and the second yoke defines a fourth concavity. The third and fourth concavities are sufficiently aligned to at least partially contain another gas storage tank. In a preferred embodiment, the assembly further includes at least one flexible strap that is operatively connected to the yokes to exert a force on at least a portion of the circumference of the tanks to retain the tanks to the yokes. Preferably, the assembly includes rubber isolators between the tanks and the cavities and straps.

The carrier assembly facilitates serviceability of the tanks by improving ease of tank handling. The strap configuration allows for variation in tank size that may result from tank pressurization. The tank carrier assembly is preferably configured so that the tanks are positioned longitudinally within the vehicle for improved packaging efficiency.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, partial cutaway top view of a chassis including hydrogen storage tanks for a vehicle;

FIG. 2 is a schematic top view of the frame of the chassis of FIG. 1;

FIG. 3 is a schematic perspective view of the frame of FIG. 2 with wheels and a front traction motor mounted thereto;

FIG. 4 is a schematic cross sectional view of the hydrogen storage tanks of FIG. 1 within a tank carrier assembly;

FIG. 5 is a schematic perspective view of the chassis of FIG. 1 illustrating a tunnel formed in the floorpan to accommodate one of the hydrogen storage tanks of FIG. 4;

FIG. 6 is a schematic perspective view of an alternative tank carrier assembly in accordance with the invention;

FIG. 7 is a schematic perspective view of the alternative tank carrier assembly with a belly pan or stone shield configured to define a portion of the lower vehicle surface;

FIG. 8 is a schematic cross-sectional view of the alternative tank carrier assembly; and

FIG. 9 is a schematic perspective view of the alternative tank carrier assembly with tanks contained therein.

### DESCRIPTION OF THE PREFERRED EMBODIMENTS

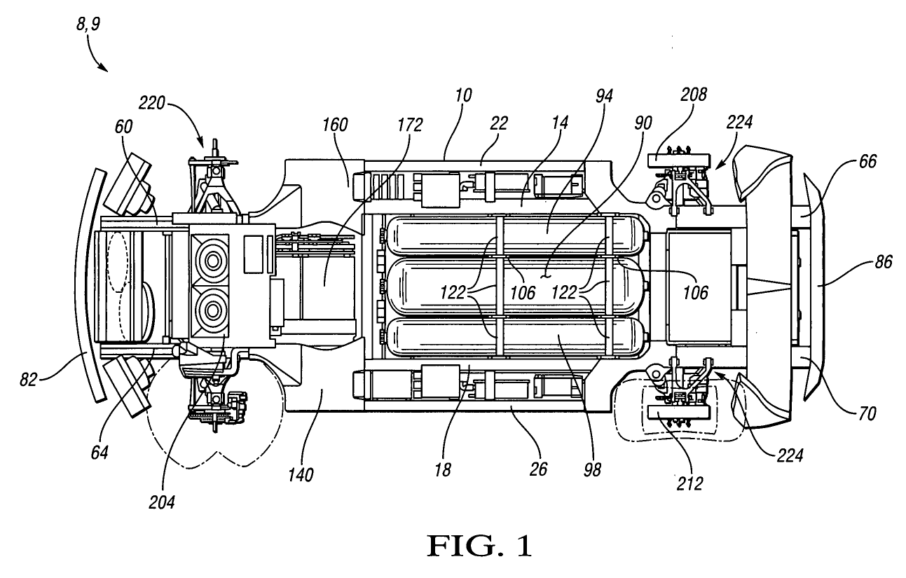

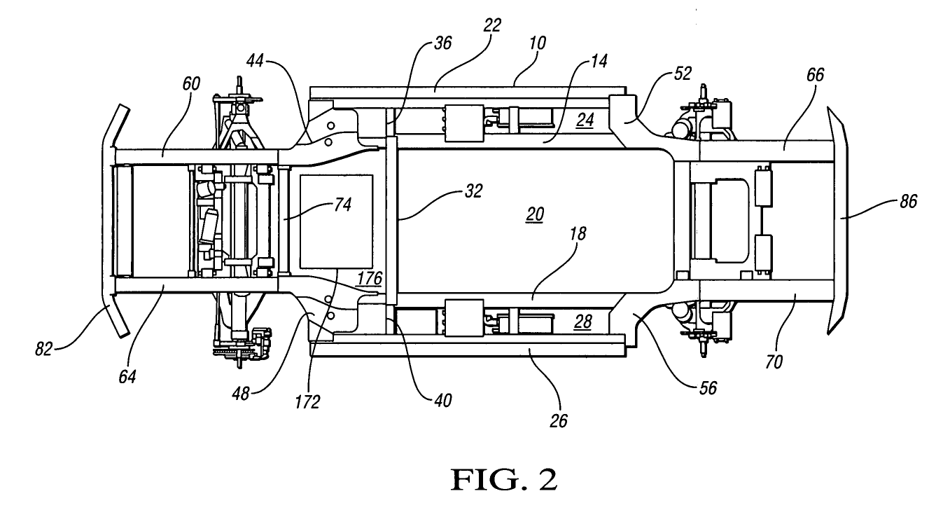

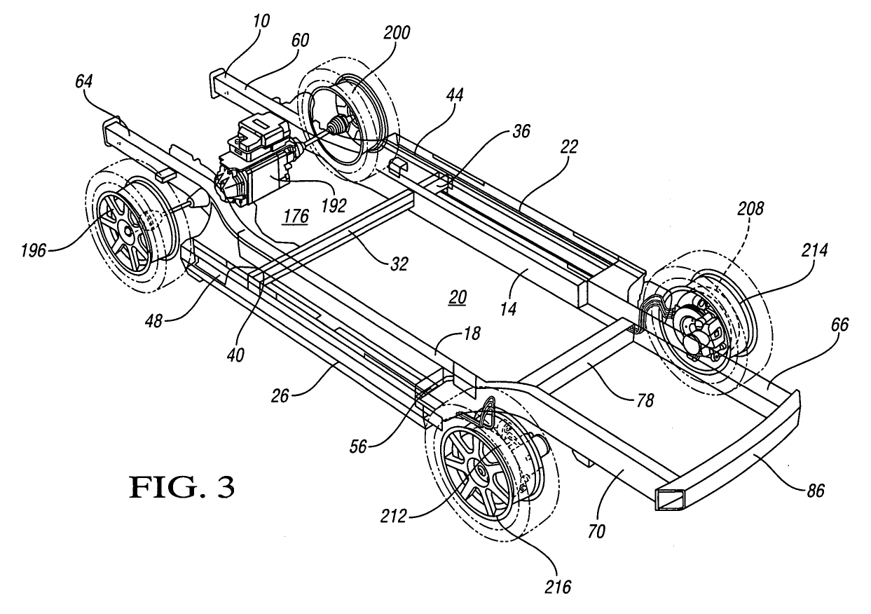

Referring to FIG. 1, a chassis 8 for a vehicle 9 is schematically depicted. The chassis includes a structural frame 10. Referring to FIGS. 2 and 3, the frame includes a first rail 14 and a second rail 18 cooperating to at least partially define a protected cavity 20 therebetween. A third rail 22 is outboard of the first rail 14 and cooperates with the first rail 14 to at least partially define a first lateral cavity 24 outboard of the protected cavity 20. A fourth rail 26 is outboard of the second rail 18 and cooperates with the second rail 18 to at least partially define a second lateral cavity 28 outboard of the protected cavity 20. Various chassis components are shown inside the lateral cavities 24, 28. Cross member 32 rigidly interconnects the first and second rails 14, 18. Cross member 36 rigidly interconnects the first and third rails 14, 22. Cross member 40 rigidly interconnects the second and fourth rails 18, 26.

The frame 10 also includes a first node 44, a second node 48, a third node 52, and a fourth node 56. The nodes, which are preferably cast, substantially rigidly interconnect various members of frame 10. More specifically, the first node 44 interconnects a first front member 60 with the first rail 14 and the third rail 22. The second node 48 interconnects a second front member 64 with the second rail 18 and the fourth rail 26. The third node 52 interconnects a first rear frame member 66 to the first and third rails 14, 22. The fourth node 66 interconnects a second rear frame member 70 to the second and fourth rails 18, 26.

Cross member 74 connects the first and second nodes. Cross member 78 connects the third and fourth nodes. A front bumper member 82 is connected to the two front members 60, 64. A rear bumper member 86 is connected to the two rear members 66, 70. Rails 14, 18, 22, 26 and frame members 60, 64, 66, 70 are preferably extruded or hydroformed aluminum tubes.

Referring specifically to FIG. 1, the vehicle 9 includes three generally cylindrical tanks 90, 94, 98 configured to store compressed hydrogen. Tank 90 is longer and has a larger diameter than tanks 94 and 98. Tanks 94 and 98 are substantially the same size, and are positioned on opposite sides of tank 90. The tanks 90, 94, 98 are at least partially located within the protected central cavity 20 of the frame 10.

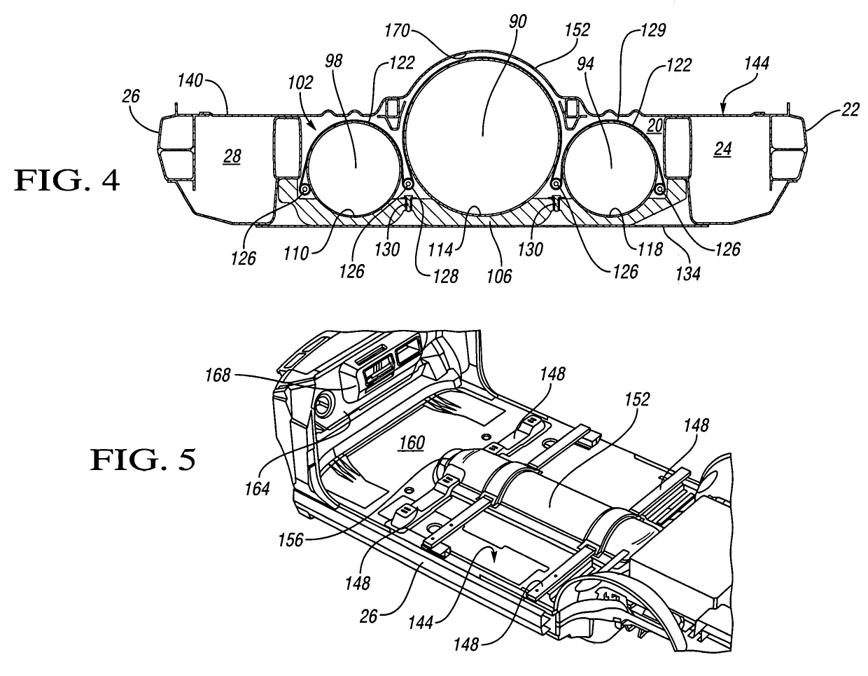

Referring to FIG. 4, wherein like reference numbers refer to like components from FIGS. 1-3, a tank carrier assembly 102 includes at least one base member, or yoke, 106 that defines three depressions or concavities 110, 114, 118. In the embodiment depicted, tank carrier 102 includes two yokes 106, as shown in FIG. 1. The yokes are transversely oriented with respect to the vehicle chassis 8, and are rigidly connected with respect to rails 14, 18 so as to span the cavity 20.

The surface defining each of the concavities is partially cylindrical having a diameter slightly larger than the diameter of one of tanks 90, 94, 98. Tank 94 is partially located within concavity 110; tank 90 is partially located within concavity 114; and tank 98 is partially located within concavity 118. Accordingly, the concavities function to at least partially locate and retain a respective tank.

The tank carrier assembly 102 further includes a flexible strap 122, shackles 130 connected to the base member 106, and rubber bushings 126 connected to the shackles. The strap 122 is preferably stainless steel. One side 128 of the strap 122 contacts a portion of the circumference of each of the tanks 90, 94, 98. The other side 129 of the strap 122 contacts a portion of the circumference of the rubber bushings 126 so that the strap 122 is in tension and exerts a force on the tanks that retains the tanks 90, 94, 98 against the base member 106. The rubber bushings 126 are elastically deformable to allow variations in the tank dimensions as a result of pressurization. Rubber isolation (not shown) is preferably employed between the stainless steel strap 122 and the tanks 90, 94, 98 to protect the tank material and to further accommodate variations in tank dimensions. Cavities 24, 28 form energy-absorbing crush spaces on respective lateral sides of the cavity 20.

A belly pan 134 seals the lower opening of the protected cavity 20. A floorpan 140 extends above and across the upper opening of the protected cavity, and forms a rigid floor surface 144 of the vehicle interior compartment or passenger space. The belly pan 134, floorpan 140, and rails 14, 18 define a hydrogen storage compartment that is at least partially coextensive with the cavity 20. Referring to FIGS. 4 and 5, the floor surface 144 is substantially flat, and provides mounting points 148 at which front and rear passenger seats (not shown) are connectable to the floor pan 140. The floor pan 140 is characterized by a tunnel 152 formed therein. The tunnel 152 is a partially cylindrical protuberance in the generally flat floor surface 144 to accommodate the size of tank 90. The forwardmost extent 156 of the tunnel does not extend significantly forward of the front seats or the mounting points 148 for the front seats, leaving a substantially flat region 160 of the vehicle floor 144 that extends longitudinally between the front seats and the bulkhead 164 or instrument panel 168. The substantially flat region 160 extends transversely from one lateral edge of the floor pan to the other lateral edge of the floor pan.

Referring again to FIG. 4, a partially cylindrical concavity 170 in which the tank 90 is partially located is opposite from the protuberance in the vehicle floor surface.

Referring again to FIGS. 1 and 2, the vehicle also includes a fuel cell stack 172. The fuel cell stack 172 is contained within a cavity 176 formed between nodes 44 and 48, as shown in FIG. 2. The fuel cell stack 172 is under the substantially flat region 160 of the floorpan 140, which is shown partially cut away in FIG. 1. The tanks 90, 94, 98 are operatively connected to the fuel cell stack 172 to selectively supply the stack 172 with hydrogen gas. Referring again to FIGS. 1 and 3, the fuel cell stack 172 provides electrical energy to traction motor 192, which is operatively connected to front wheels 196, 200. The traction motor is located underneath an HVAC unit, shown at 204 in FIG. 1. Individual rear wheel hub motors 208, 212 drive rear wheels 214, 216, respectively. The front wheels 196, 200 are rotatably connected to a front suspension system 220, which is mounted to the frame 10. Rear wheels 214, 216 are rotatably connected to a rear suspension system 224, which is mounted to the frame 10. The wheels each have a tire mounted thereon.

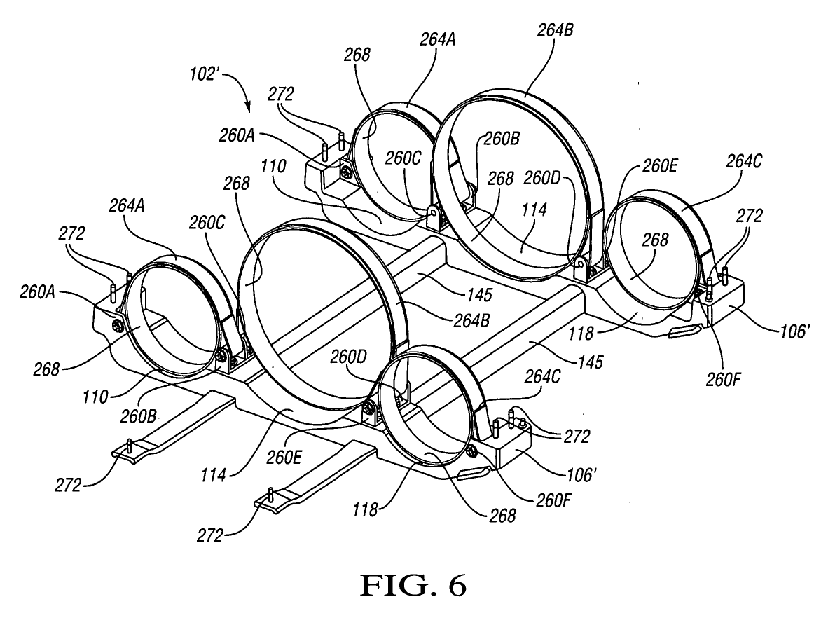

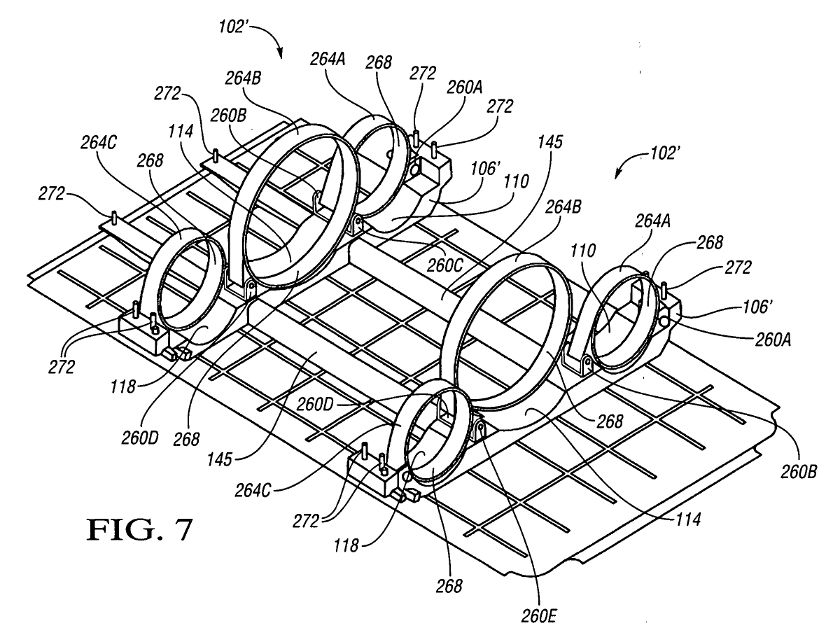

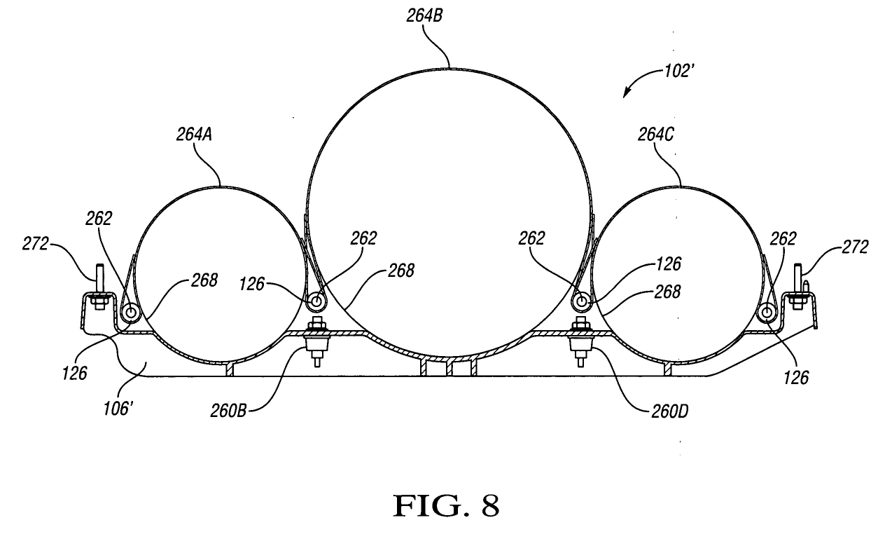

Referring to FIGS. 6-9, wherein like reference numbers refer to like components from FIGS. 1-5, an alternative tank carrier assembly 102′ is schematically depicted. Tank carrier assembly 102′ includes two base members, or yokes, 106′. The yokes 106′ are parallel to one another, spaced a distance apart from one another, and interconnected by two members 145, which are aluminum tubes in the embodiment depicted. Each yoke 106′ has six shackles 260A, 260B, 260C, 260D, 260E, 260F rigidly mounted thereto. On each yoke 106′, shackles 260A, 260B are positioned on opposite sides of concavities 110; shackles 260C, 260D are positioned on opposite sides of concavity 114; and shackles 260E, 260F are positioned on opposite sides of concavity 118. Each shackle also has a rubber bushing 126 connected thereto about a pin 262.

Each yoke also has three straps 264A, 264B, 264C connected thereto. Each strap forms a loop on opposite ends. On each yoke 106′, strap 264A is operatively connected to the bushing 126 of shackle 260A by the loop at one end, and to the bushing of shackle 260B at the other end. Strap 264B is operatively connected to the bushing of shackle 260C by the loop at one end, and to the bushing of shackle 260D by the loop at the other end. Strap 264C is operatively connected to the bushing of shackle 260E by the loop at one end, and to the bushing of shackle 260F by the loop at the other end.

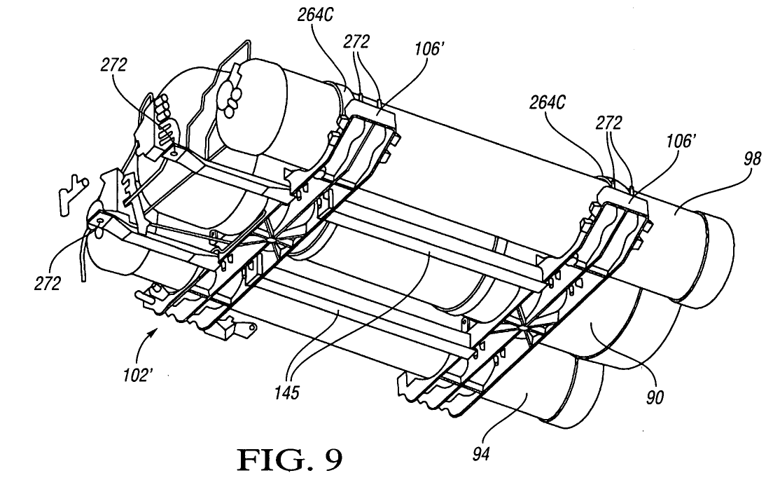

Each strap has a ring-shaped rubber isolator 268 attached thereto. Each rubber isolator is configured to surround the circumference of a corresponding tank to protect the tank surface from contact with the strap and the yoke 106′. Each of the straps is in tension to provide a compressive force to a respective rubber isolator 268, and accordingly to one of the tanks 90, 94, 98 extending through the rubber isolator and within the concavities 110, 114, 118. The compressive force acts to retain the corresponding tank against the yokes. Referring specifically to FIG. 9, tank 90 is at least partially located within the concavity 114 of both yokes 106′; tank 94 is at least partially located within the concavity 110 of both yokes 106′, and tank 98 is at least partially located within the concavity 118 of both yokes 106′. Thus, straps 264A at least partially surround the circumference of, and exert a compressive force on, tank 94, straps 264B at least partially surround the circumference of, and exert a compressive force on, tank 90, and straps 264C at least partially surround the circumference of, and exert a compressive force on, tank 98.

The members 145 each have a fastening element, such as threaded fastener 272, at one end. The yokes 106′ also include two fastening elements 272 at each end. In the embodiment depicted, the fastening elements 272 on members 145 connect to corresponding fastening elements on the frame member shown at 32 in FIG. 2, so as to rigidly connect the members 145 to frame member 32. For example, the fastening elements 272 may extend through holes in the frame member and be secured by a bolt as understood by those skilled in the art. The fastening elements 272 on one side of yokes 106′ fasten to corresponding elements on rail 14 in a like manner to rigidly connect the yokes 106′ to the rail 14. The fasteners 272 on the other side of yokes 106′ fasten to corresponding elements on rail 18 in a like manner to rigidly connect the yokes 106′ to rail 18. The tank carrier assembly may thus provide increased structural rigidity to the frame 10 of the chassis 8. The fastening elements are selectively releasable from the frame 10 to allow selective removal of the tank carrier assembly from the protected compartment shown at 20 in FIG. 4. Thus, by disengaging the fastening elements 272, the tank carrier assembly 102′ can be lowered for removal and inspection. It should be noted that a tank carrier assembly may be configured to contain a single tank of any shape within the scope of the claimed invention.

Energy absorption members (not shown) may be included at both the front and the rear ends of the assembly. The energy absorption members would be configured to deform in an impact situation to absorb energy. It may be desirable for the energy absorption members to define concavities configured to at least partially contain the end portion of a respective tank.

It should be noted that it may be desirable to replace the shackles with T-bolts to improve the manufacturability of the tank carrier assembly.

While the best modes for carrying out the invention have been described in detail, those familiar with the art to which this invention relates will recognize various alternative designs and embodiments for practicing the invention within the scope of the appended claims.

1. A tank carrier for a vehicle comprising:
a first yoke defining a first concavity; a second yoke spaced a distance apart from the first yoke, and defining a second concavity;
a member interconnecting the first yoke and the second yoke;
wherein the first and second concavities are sufficiently aligned to at least partially contain a first compressed gas storage tank.

2. The tank carrier of claim 1, wherein the first yoke defines a third concavity and the second yoke defines a fourth concavity; and wherein the third and fourth concavities are sufficiently aligned to at least partially contain a second compressed gas storage tank.

3. The tank carrier of claim 2, further comprising at least one strap operatively connected to the first yoke and sufficiently configured to exert a compressive force on the first and second compressed gas storage tanks when the first and second compressed gas storage tanks are at least partially contained within the first and third concavities, respectively.

4. The tank carrier of claim 3, further comprising at least one elastomeric isolator attached to said at least one strap so as to be between said at least one strap and said first and second tanks when said first and second tanks are in the first and third concavities, respectively.

5. The tank carrier of claim 3, further comprising a fastening element connected to said first yoke between said first and third concavities; wherein said at least one strap is a single strap characterized by a first side and a second side; wherein said first side contacts said fastening element; and wherein said second side faces said first and third concavities to exert a compressive force on said first and second tanks.

6. The tank carrier of claim 5, wherein said fastening element includes an elastomeric member; and wherein said first side contacts said elastomeric member.

7. The tank carrier of claim 3, wherein said at least one strap includes a first strap and a second strap; wherein said first strap is operatively connected to said first yoke on opposite sides of the first concavity; and wherein said second strap is operatively connected to said first yoke on opposite sides of the third concavity.

8. The tank carrier of claim 1, wherein said first and second concavities are at least partially cylindrical to accommodate a cylindrical storage tank.

9. A tank carrier comprising:
a first yoke defining first and second concavities; a second yoke spaced a distance apart from the first yoke, and defining third and fourth concavities;
wherein the first and third concavities are sufficiently aligned to at least partially contain a first compressed gas storage tank; and
wherein the second and fourth concavities are sufficiently aligned to at least partially contain a second compressed gas storage tank.

10. The tank carrier of claim 9, further comprising a first strap having a respective first side and a second side; a second strap having a respective first side and a second side; a first fastening element operatively connected to the first yoke between the first and second concavities; a second fastening element operatively connected to the second yoke between the third and fourth concavities; wherein the first side of the first strap contacts the first fastening element and the second side of the first strap faces the first and second concavities; and wherein the first side of the second strap contacts the second fastening element and the second side of the second strap faces the third and fourth concavities.

11. The tank carrier of claim 9, further comprising a first strap operatively connected to the first yoke on opposite sides of the first concavity; a second strap operatively connected to the first yoke on opposite sides of the second concavity; a third strap operatively connected to the second yoke on opposite sides of the third concavity; and a fourth strap operatively connected to the second yoke on opposite sides of the fourth concavity; wherein the first and third straps are sufficiently configured to exert a compressive force on the first tank when the first tank is at least partially contained in the first and third concavities; and wherein the second and fourth straps are sufficiently configured to exert a compressive force on the second tank when the second tank is at least partially contained in the second and fourth concavities.

12. A vehicle comprising:
a first yoke being transversely oriented in the vehicle and defining first and second partially cylindrical concavities; a second yoke being transversely oriented, spaced a distance apart from the first yoke, and defining third and fourth partially cylindrical concavities;
a member rigidly interconnecting the first yoke and the second yoke;
a first generally cylindrical compressed gas storage tank being longitudinally oriented within the vehicle and at least partially located in the first and third concavities;
a second generally cylindrical compressed gas storage tank being longitudinally oriented within the vehicle and at least partially located in the second and fourth concavities;
a first set of shackles with rubber bushings connected to the first yoke; a second set of shackles with rubber bushings connected to the second yoke; a first strap operatively connected to the first set of shackles to exert a force on at least a portion of the circumference of the first and second tanks; and a second strap operatively connected to the second set of shackles to exert a force on at least a portion of the first and second tanks.
